(19) United States
(12) Patent Application Publication
(10) Pub. No.: US 2025/0293787 A1
(43) Pub. Date: Sep. 18, 2025

(54) RADIO DEVICE, RADIO DEVICE CONTROL METHOD, AND NON-TRANSITORY COMPUTER READABLE MEDIUM FOR PROGRAM

(71) Applicant: Panasonic Automotive Systems Co., Ltd., Kanagawa (JP)

(72) Inventors: Tomoya OSAKI, Kanagawa (JP); Masataka YAMAMOTO, Kanagawa (JP); Tomoyasu FUJISHIMA, Kanagawa (JP); Yohei ASADA, Kanagawa (JP)

(21) Appl. No.: 19/072,266

(22) Filed: Mar. 6, 2025

(30) Foreign Application Priority Data
Mar. 13, 2024 (JP) 2024-039450

(51) Int. Cl. H04H 20/10; H04H 20/12; H04H 20/20

(52) U.S. Cl. CPC H04H 20/106; H04H 20/12; H04H 20/20

(57) ABSTRACT

There is provided a radio device including: a reception unit configured to receive a digital radio signal as a radio signal of digital radio broadcasting, an analog radio signal as a radio signal of analog radio broadcasting, and an IP radio signal as a radio signal of IP radio broadcasting, the digital radio broadcasting, the analog radio broadcasting, and the IP radio broadcasting being related to simulcast broadcasting; an evaluation unit configured to perform audio quality evaluation on an analog radio audio by using a digital radio audio based on the digital radio signal and the analog radio audio based on the analog radio signal; and a switching unit configured to switch, based on the audio quality evaluation, an audio output of the digital radio audio to any one of the analog radio audio and an IP radio audio based on the IP radio signal.

### CROSS-REFERENCE TO RELATED APPLICATIONS

This application is based on and claims priority under 35 USC 119 from Japanese Patent Application No. 2024-039450 filed on Mar. 13, 2024, the contents of which are incorporated herein by reference.

### TECHNICAL FIELD

The present disclosure relates to a radio device, a radio device control method, a program, and a non-transitory computer readable medium for the program.

### BACKGROUND ART

In the related art, in a radio device mounted on a vehicle or the like, a reception environment of a signal changes with movement of the vehicle on which the radio device is mounted, and thus there is a demand for audio output control that takes such an environmental change into account.

In addition, in the radio device, broadcasting of the same content is received by a different method or the like, and the same content is switched and output. For example, JP2017-108229A discloses a configuration in which, when a reception condition of radio broadcasting during reception deteriorates, another radio broadcasting related to simulcast broadcasting is specified and switched.

For example, there is a difference in characteristics in the simulcast broadcastings due to different methods. Therefore, when the switching is performed between the simulcast broadcastings, it is desirable to perform the switching in consideration of states and characteristics before and after the switching.

### SUMMARY OF INVENTION

The present disclosure provides a radio device mounted on a vehicle or the like, a control method thereof, a program, and a non-transitory computer readable medium for the program, which can evaluate the audio quality of radio broadcasting and appropriately switch radio audio.

According to an illustrative aspect of the present disclosure, a radio device includes: a reception unit configured to receive a digital radio signal as a radio signal of digital radio broadcasting, an analog radio signal as a radio signal of analog radio broadcasting, and an IP radio signal as a radio signal of IP radio broadcasting, the digital radio broadcasting, the analog radio broadcasting, and the IP radio broadcasting being related to simulcast broadcasting; an evaluation unit configured to perform audio quality evaluation on an analog radio audio by using a digital radio audio based on the digital radio signal and the analog radio audio based on the analog radio signal; and a switching unit configured to switch, based on the audio quality evaluation, an audio output of the digital radio audio to any one of the analog radio audio and an IP radio audio based on the IP radio signal.

According to another illustrative aspect of the present disclosure, a radio device control method includes: a reception operation of receiving a digital radio signal as a radio signal of digital radio broadcasting, an analog radio signal as a radio signal of analog radio broadcasting, and an IP radio signal as a radio signal of IP radio broadcasting, the digital radio broadcasting, the analog radio broadcasting, and the IP radio broadcasting being related to simulcast broadcasting; an evaluation operation of performing audio quality evaluation on an analog radio audio by using a digital radio audio based on the digital radio signal and the analog radio audio based on the analog radio signal; and a switching operation of switching, based on the audio quality evaluation, an audio output of the digital radio audio to any one of the analog radio audio and an IP radio audio based on the IP radio signal.

According to another illustrative aspect of the present disclosure, there are provided a program for causing a computer to execute a control process, and a non-transitory computer readable medium storing the program. The control process includes: a reception operation of receiving a digital radio signal as a radio signal of digital radio broadcasting, an analog radio signal as a radio signal of analog radio broadcasting, and an IP radio signal as a radio signal of IP radio broadcasting, the digital radio broadcasting, the analog radio broadcasting, and the IP radio broadcasting being related to simulcast broadcasting; an evaluation operation of performing audio quality evaluation on an analog radio audio by using a digital radio audio based on the digital radio signal and the analog radio audio based on the analog radio signal; and a switching operation of switching, based on the audio quality evaluation, an audio output of the digital radio audio to any one of the analog radio audio and an IP radio audio based on the IP radio signal.

Any combination of the above components, and conversion of an expression of the present disclosure between a method, a device, a system, a storage medium, a computer program, and the like are also effective in an aspect of the present disclosure.

According to the present disclosure, it is possible to evaluate the audio quality of the radio broadcasting and appropriately switch the radio audio in a radio device mounted on a vehicle or the like.

### BRIEF DESCRIPTION OF DRAWINGS

FIG. 1 is a block diagram illustrating a configuration example of a radio device according to Embodiment 1;

FIG. 2 is a block diagram illustrating a configuration example of an audio quality evaluation unit according to Embodiment 1;

FIG. 3 is a conceptual diagram illustrating evaluation of a signal waveform of each broadcast;

FIG. 4 is a flowchart of an audio output process according to Embodiment 1;

FIG. 5 is a flowchart of an analog radio quality evaluation process according to Embodiment 1;

FIG. 6 is a graph illustrating an example of quality evaluation according to Embodiment 1;

FIG. 7 is a block diagram illustrating a configuration example of an audio quality evaluation unit according to Modification 3;

FIG. 8 is a block diagram illustrating a configuration example of an audio quality evaluation unit according to Modification 4;

FIG. 9 is a block diagram illustrating a configuration example of an audio quality evaluation unit according to Modification 5;

FIG. 10 is a block diagram illustrating a configuration example of an audio quality evaluation unit according to Modification 6;

FIG. 11 is a block diagram illustrating a configuration example of an audio quality evaluation unit according to Modification 7;

FIG. 12 is a block diagram illustrating a configuration example of a radio device according to Embodiment 2;

FIG. 13 is a block diagram illustrating another configuration example of the radio device according to Embodiment 2; and

FIG. 14 is a block diagram illustrating another configuration example of the radio device according to Embodiment 2.

### DESCRIPTION OF EMBODIMENTS

Hereinafter, embodiments that specifically disclose a radio device, a radio device control method, and a program according to the present disclosure will be described in detail with reference to the accompanying drawings as appropriate. However, unnecessarily detailed descriptions may be omitted. For example, the detailed description of well-known matters or the redundant description of substantially the same configuration may be omitted. This is to avoid unnecessary redundancy of the following description and facilitate understanding of those skilled in the art. The accompanying drawings and the following description are provided for those skilled in the art to fully understand the present disclosure, and are not intended to limit the subject matters described in the claims.

### FINDINGS OF INVENTOR

In recent years, as a vehicle becomes more functional and more electric, noise radiated from the vehicle or an in-vehicle device interferes with a radio signal, and a reception condition of a radio signal in a radio device may deteriorate. For example, in analog radio broadcasting, audio quality is likely to deteriorate due to external factors such as multipath, adjacent interference, vehicle noise, and disturbance noise. On the other hand, digital radio broadcasting is resistant to noise and has a relatively small influence of vehicle noise or the like, but tends to have a narrower reception area than the analog radio broadcasting. In a case where the digital radio broadcasting is output by an audio in an in-vehicle radio, it is assumed that the reception condition rapidly deteriorates when the broadcasting goes out of exits from the reception area. In this case, the analog radio broadcasting having a wider reception area and related to simulcast broadcasting is considered as a switching destination of an audio source. However, due to an influence of noise, under certain circumstances, switching to the analog radio broadcasting may not be suitable in terms of audio quality. More specifically, in a case where the analog radio broadcasting is switched when the reception condition of the digital radio broadcasting deteriorates, the reception condition itself of the analog radio broadcasting may not be good. In such a case, the quality of the audio output remains low before and after the switching.

For example, in the switching between the digital radio broadcasting and the analog radio broadcasting, the switching between the simulcast broadcastings can be performed using a digital service identifier and an analog identifier. At this time, when the switching is performed based only on identifier information, the audio quality after the switching is not guaranteed, so that a difference in audio quality before and after the switching may become large.

### Embodiment 1

### [Device Configuration]

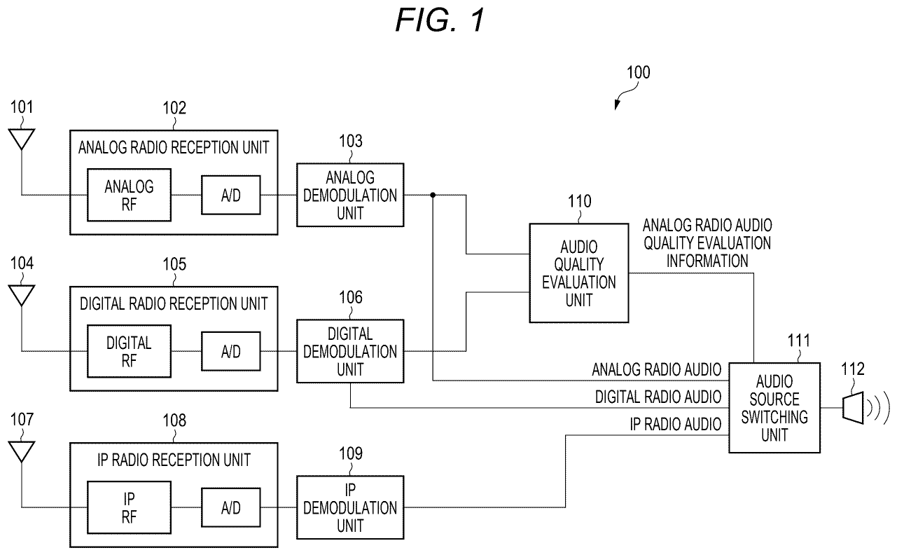

FIG. 1 is a block diagram illustrating a configuration example of a radio device according to Embodiment 1. A radio device 100 according to the present embodiment can receive the analog radio broadcasting, the digital radio broadcasting, and the IP radio broadcasting, and is capable of outputting an audio by switching to one of the analog radio broadcasting, the digital radio broadcasting, and the IP radio broadcasting. Each of the analog radio broadcasting, the digital radio broadcasting, and the IP radio broadcasting includes radio signals corresponding to a plurality of services, and a service selected from the plurality of services is output as an audio. In the present embodiment, it is assumed that at least some of the analog radio broadcasting, the digital radio broadcasting, and the IP radio broadcasting corresponding to a plurality of services are related to the simulcast broadcasting in which broadcasting of the same content is performed.

In general, the digital radio broadcasting has high noise resistance and good audio quality in the reception area, but when the broadcasting goes out of the reception area, the audio quality tends to deteriorate, such as sudden interruption of audio. On the other hand, the analog radio broadcasting has a reception area wider than that of the digital radio broadcasting, and it may be possible to output an audio even at a position where the digital radio broadcasting cannot be received. However, the analog radio broadcasting tends to be affected by the environment or the like, and the audio quality tends to deteriorate as compared with the digital radio broadcasting.

The IP radio broadcasting has high audio quality, and may be capable of outputting an audio outside the area of a broadcast wave of the digital radio broadcasting or the analog radio broadcasting. On the other hand, the IP radio broadcasting has a delay longer than that of the broadcast waves of the digital radio broadcasting and the analog radio broadcasting, and costs such as payment of a fee associated with use may be generated.

In consideration of characteristics of each radio broadcasting as described above, the radio device 100 according to the present embodiment is configured to switch the audio output of each radio broadcasting.

The radio device 100 according to the present embodiment is assumed to be, for example, an in-vehicle radio device that is mounted on a vehicle (not illustrated) and is operable by a user. The in-vehicle radio device may be configured as a single device that outputs a radio signal, or may be configured as one function of a navigation device. Further, the term “vehicle” is not limited to an ordinary passenger vehicle, and may be any movable body such as a two-wheeled vehicle, a bus, or a truck. Further, the configuration illustrated in FIG. 1 is an example, and one part may be divided into a plurality of parts, or a plurality of parts may be integrated into one. Here, only parts related to the functions according to the present embodiment are illustrated, and other functions may be further provided.

An antenna 101 receives a radio signal related to the analog radio broadcasting and transmits the radio signal to an analog radio reception unit 102. An antenna 101 receives a radio signal of analog radio broadcasting in a predetermined frequency band transmitted from a neighboring base station. There is no particular limitation on the frequency band or standard. An antenna 104 receives a radio signal related to the digital radio broadcasting and transmits the radio signal to a digital radio reception unit 105. An antenna 107 receives a radio signal related to IP radio broadcasting and transmits the radio signal to an IP radio reception unit 108.

The analog radio reception unit 102 performs filtering of a radio signal of analog radio broadcasting, A/D conversion, and the like on the received radio signal, and provides the radio signal to an analog demodulation unit 103. The digital radio reception unit 105 performs filtering of a radio signal of digital radio broadcasting, A/D conversion, and the like on the received radio signal, and provides the radio signal to a digital demodulation unit 106. The IP radio reception unit 108 performs filtering of a radio signal of IP radio broadcasting, A/D conversion, and the like on the received radio signal, and provides the radio signal to an IP demodulation unit 109.

The analog demodulation unit 103 acquires and demodulates a radio signal of a frequency designated by a selection station of the user or the like from the analog radio signals received by the analog radio reception unit 102. Acquisition of the radio signal of the designated frequency may be referred to as filtering. The analog demodulation unit 103 sets the demodulated analog radio signal as an analog radio audio, and transmits the analog radio audio to an audio quality evaluation unit 110 and an audio source switching unit 111. The analog demodulation unit 103 may further perform a noise identification or a noise removal process.

The digital demodulation unit 106 acquires and demodulates a radio signal of a frequency designated by a selection station of the user or the like from the digital radio signals received by the digital radio reception unit 105. The digital demodulation unit 106 sets the demodulated digital radio signal as a digital radio audio, and transmits the digital radio audio to the audio quality evaluation unit 110 and the audio source switching unit 111. The digital demodulation unit 106 may further perform a noise identification or noise removal process.

The IP demodulation unit 109 acquires a radio signal of a frequency designated by a selection station of the user or the like from the IP radio signals received by the IP radio reception unit 108, and demodulates the received radio signal. The IP demodulation unit 109 sets the demodulated IP radio signal as an IP radio audio, and transmits the IP radio audio to the audio source switching unit 111.

The audio quality evaluation unit 110 performs audio quality evaluation on the analog radio audio received from the analog demodulation unit 103 based on the digital radio audio received from the digital demodulation unit 106. Then, the audio quality evaluation unit 110 outputs audio quality evaluation information as an evaluation result of the analog radio audio to the audio source switching unit 111.

The audio source switching unit 111 controls switching of an audio source to be output as an audio from among the acquired analog radio audio, digital radio audio, and IP radio audio, and outputs the audio source to the audio output unit 112. As will be described in detail later, in the present embodiment, when the reception condition of the digital radio audio deteriorates, an audio source to be switched is determined based on the audio quality evaluation information by the audio quality evaluation unit 110. The audio output unit 112 outputs the acquired radio audio using a speaker or the like.

Each block illustrated in FIG. 1 may be implemented by a control unit, a storage unit, or the like (not illustrated). The control unit (not illustrated) may be implemented by using, for example, a central processing unit (CPU), a micro processing unit (MPU), a digital signal processor (DSP), a graphical processing unit (GPU), or a field programmable gate array (FPGA).

The storage unit (not illustrated) is a storage area for storing and retaining various data, and may be implemented by, for example, a non-volatile storage area such as a read only memory (ROM) or a hard disk drive (HDD), or a volatile storage area such as a random access memory (RAM). For example, the control unit may implement some or all of the functions of the blocks illustrated in FIG. 1 by reading and executing various data and programs stored in the storage unit.

Although not illustrated in FIG. 1, a storage unit that holds and manages a radio signal before demodulation or a radio signal after demodulation by the analog demodulation unit 103, the digital demodulation unit 106, and the IP demodulation unit 109 for a certain period may be provided. The audio quality evaluation unit 110 may perform audio quality evaluation using the stored radio audio.

### (Audio Quality Evaluation Unit)

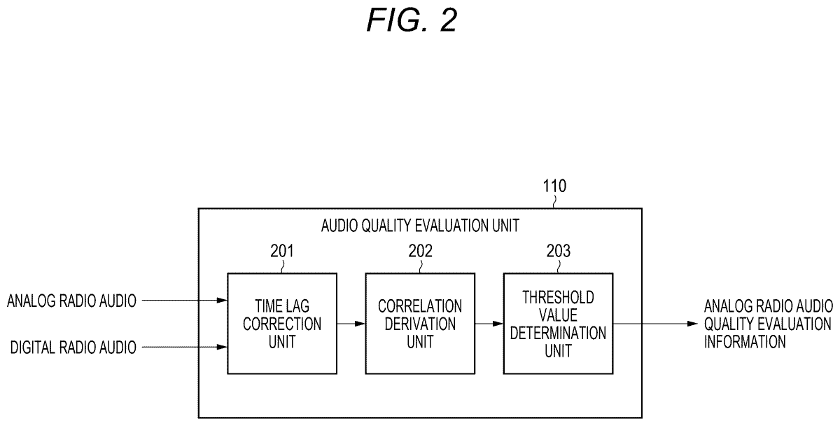

FIG. 2 is a block diagram illustrating a configuration example of the audio quality evaluation unit 110 according to the present embodiment. The audio quality evaluation unit 110 receives the analog radio audio and the digital radio audio corresponding to the analog radio broadcasting and the digital radio broadcasting, respectively, which are related to simulcast broadcasting, and outputs the audio quality evaluation information of the received analog radio audio.

The audio quality evaluation unit 110 includes a time lag correction unit 201, a correlation derivation unit 202, and a threshold value determination unit 203. The time lag correction unit 201 derives a time lag between the analog radio audio and the digital radio audio, and corrects the time lag. Generally, since the digital radio audio requires time for demodulation, the digital radio audio tends to be delayed. Since the analog radio audio and the digital radio audio are the same content, the characteristics of the waveform are similar. Therefore, it is possible to specify the time lag by grasping the characteristics. A known method may be used for deriving the time lag, and a detailed description thereof is omitted here.

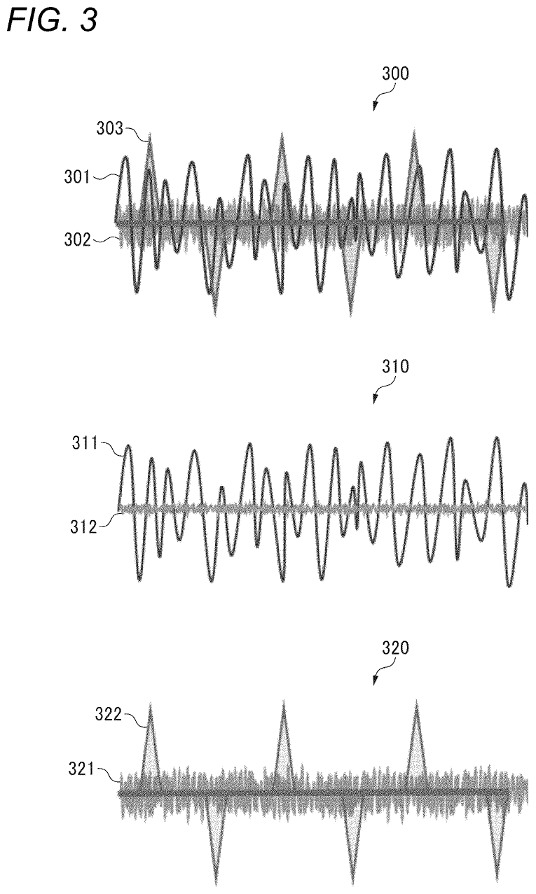

The correlation derivation unit 202 calculates an inner product of the analog radio audio and the digital radio audio obtained by correcting the time lag by the time lag correction unit 201. FIG. 3 is a diagram illustrating an example of an analog radio audio 300 and a digital radio audio 310. The analog radio audio 300 and the digital radio audio 310 are audio signals in which time lags are corrected, and are the same content. The analog radio audio 300 includes an audio signal 301, residual noise 302, and periodic noise 303. The digital radio audio 310 includes an audio signal 311 and the residual noise 302. By taking the inner product of the audios, a degree of coincidence of the waveforms is calculated. The correlation derivation unit 202 outputs the calculated degree of coincidence to the threshold value determination unit 203.

The threshold value determination unit 203 compares the degree of coincidence calculated by the correlation derivation unit 202 with a predetermined threshold value, and performs audio quality evaluation on the analog radio audio. As described above, the digital radio broadcasting has high noise resistance. Therefore, when the digital radio audio and the analog radio audio which are the same content are compared and the degree of coincidence is low, it can be considered that noise is superimposed on the analog radio audio. A threshold value is set in advance in consideration of the degree of noise, and when the degree of coincidence is lower than the threshold value, it is determined that the quality of the analog radio audio is low. The threshold value determination unit 203 acquires the audio quality evaluation information of the analog radio audio by performing the determination as described above, and outputs the audio quality evaluation information to the audio source switching unit 111.

### [Process Flow]

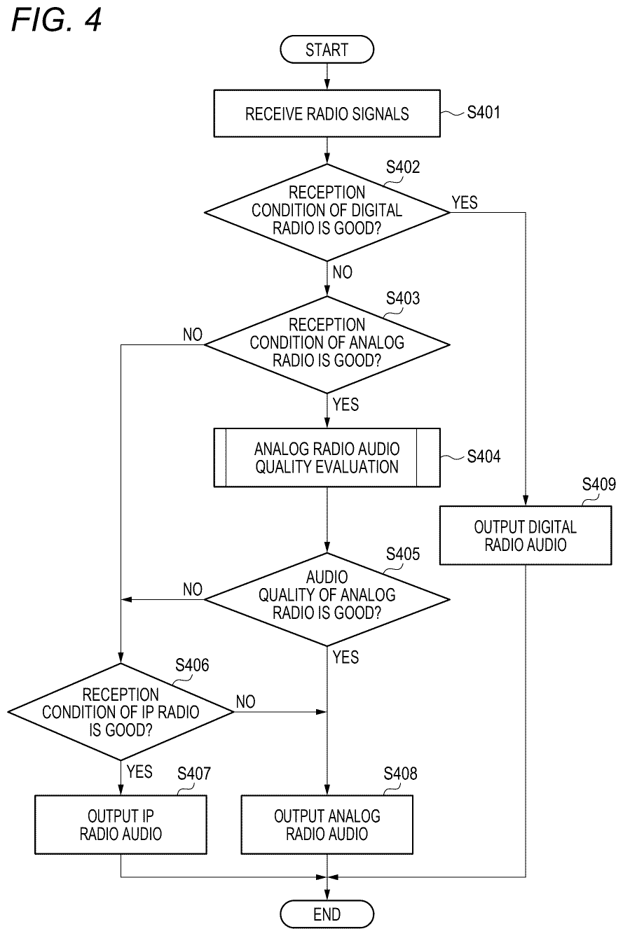

FIG. 4 is a flowchart of a switching process according to the present embodiment. This process flow is realized in cooperation with each block of the radio device 100 illustrated in FIG. 1. For ease of explanation, a processing entity will be collectively described as the radio device 100.

In this example, the analog radio broadcasting, the digital radio broadcasting, and the IP radio broadcasting, which are related to the simulcast broadcasting, can be received, and switching from the digital radio broadcasting during audio output is assumed. Whether there is a corresponding simulcast broadcasting in each radio broadcasting may be determined based on, for example, identification information assigned to each radio signal. This process flow is repeatedly performed at predetermined time intervals.

The radio device 100 receives radio signals of radio broadcastings in a certain service content (step S401). Here, the service content may be specified by the user using, for example, a user interface included in the radio device 100, or the radio device 100 may select any service according to the preference of the user.

The radio device 100 determines whether the reception condition of the digital radio broadcasting among the radio signals received in step S401 is good (step S402). When the reception condition of the digital radio broadcasting is good (step S402: YES), the process of the radio device 100 proceeds to step S409. On the other hand, when the reception condition of the digital radio broadcasting is not good (step S402: NO), the process of the radio device 100 proceeds to step S403.

The radio device 100 determines whether the reception condition of the analog radio broadcasting among the radio signals received in step S401 is good (step S403). When the reception condition of the analog radio broadcasting is good (step S403: YES), the process of the radio device 100 proceeds to step S404. On the other hand, when the reception condition of the analog radio broadcasting is not good (step S403: NO), the process of the radio device 100 proceeds to step S406.

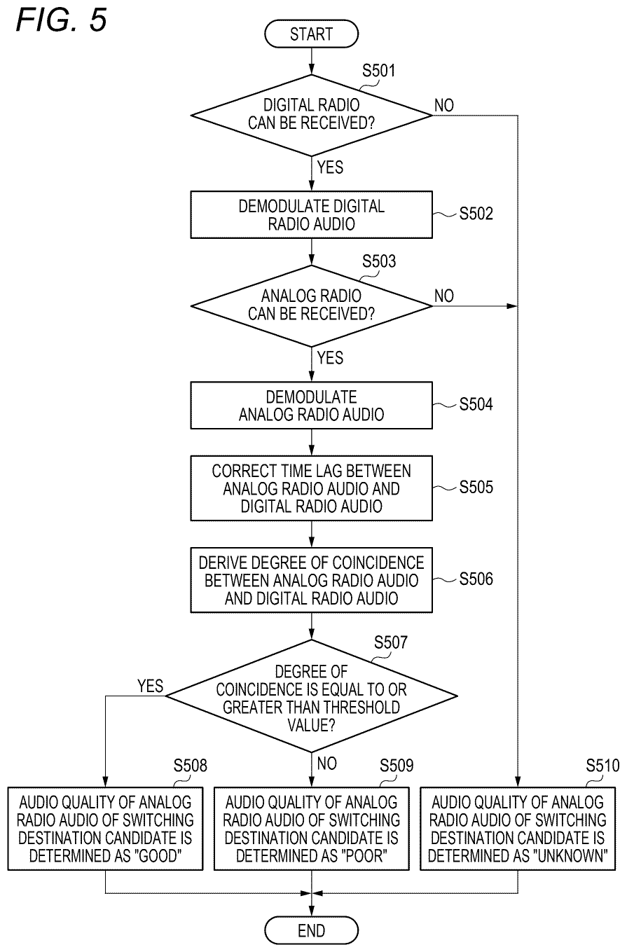

The radio device 100 performs an audio quality evaluation process on the analog radio audio (step S404). Details of this step will be described later with reference to FIG. 5. Thereafter, the process performed by the radio device 100 proceeds to step S405.

The radio device 100 determines whether the audio quality of the analog radio audio is good based on the audio quality evaluation information obtained in the audio quality evaluation process of step S404 (step S405). When the audio quality of the analog radio audio is good (step S405: YES), the process of the radio device 100 proceeds to step S408. On the other hand, when the audio quality of the analog radio audio is not good (step S405: NO), the process of the radio device 100 proceeds to step S406.

The radio device 100 determines whether the reception condition of the IP radio broadcasting among the radio signals received in step S401 is good (step S406). The availability of the IP radio broadcasting may be set by a user of the radio device 100 in consideration of the occurrence of payment of a fee or the like. In this case, it may also be determined whether the IP radio broadcasting is available. When the reception condition of the IP radio broadcasting is good (step S406: YES), the process of the radio device 100 proceeds to step S407. On the other hand, when the reception condition of the IP radio broadcasting is not good (step S406: NO), the process of the radio device 100 proceeds to step S408. In the present embodiment, when the reception condition of the analog radio broadcasting is not good and the reception condition of the IP radio broadcasting is not good, the analog radio audio is switched to an audio source so that the audio output does not become silent.

The radio device 100 switches the audio source so as to output the IP radio audio (step S407). Then, this process flow ends.

The radio device 100 switches the audio source to output the analog radio audio (step S408). Then, this process flow ends.

The radio device 100 switches the audio source to output the digital radio audio (step S409). When the digital radio audio has already been output, the audio output is continued. Then, this process flow ends.

### (Audio Quality Evaluation Process of Analog Radio Audio)

FIG. 5 is a flowchart of an audio quality evaluation process of the analog radio audio according to the present embodiment. This process corresponds to the process of step S404 in FIG. 4.

The radio device 100 determines whether the radio signal of the digital radio broadcasting can be received (step S501). Whether the radio signal of the digital radio broadcasting can be received may be determined based on whether the radio signal of the digital radio broadcasting can be received at a signal level to be used as a reference for deriving the degree of coincidence to be described later. Further, the radio signal of the digital radio broadcasting received here may be a radio signal within a predetermined range preceding a current time point by a predetermined period. In this case, the radio signal within the range may be held and managed in a storage unit (not illustrated). When the radio signal of the digital radio broadcasting can be received (step S501: YES), the process of the radio device 100 proceeds to step S502. On the other hand, when the radio signal of the digital radio broadcasting cannot be received (step S501: NO), the process of the radio device 100 proceeds to step S510.

The radio device 100 demodulates the received radio signal of the digital radio broadcasting to acquire a digital radio audio (step S502).

The radio device 100 determines whether the radio signal of the analog radio broadcasting can be received (step S503). Whether the radio signal of the analog radio broadcasting can be received may be determined based on whether the radio signal of the analog radio broadcasting can be received at a signal level that can be an evaluation determination target for deriving the degree of coincidence to be described later. Similarly to the radio signal of the digital radio broadcasting in step S501, the radio signal of the analog radio broadcasting received here may be a radio signal within a predetermined range preceding a current time point by a predetermined period. In this case, the radio signal within the range may be held and managed in a storage unit (not illustrated). When the radio signal of the analog radio broadcasting can be received (step S503: YES), the process of the radio device 100 proceeds to step S504. On the other hand, when the radio signal of the analog radio broadcasting cannot be received (step S503: NO), the process of the radio device 100 proceeds to step S510.

The radio device 100 demodulates received the radio signal of the analog radio broadcasting to acquire an analog radio audio (step S504).

The radio device 100 corrects a time lag between the digital radio audio acquired in step S502 and the analog radio audio acquired in step S504 (step S505). As described above, since the digital radio audio and the analog radio audio have the same content, waveform characteristics can be the same. Thus, by comparing the waveform characteristics, the time lag can be specified and corrected.

The radio device 100 derives the degree of coincidence between the digital radio audio and the analog radio audio whose time lag has been corrected in step S505 (step S506). The degree of coincidence can be derived by obtaining the inner product of the waveform signals of the digital radio audio and the analog radio audio.

The radio device 100 determines whether the degree of coincidence derived in step S506 is equal to or greater than a predetermined threshold value (step S507). When the degree of coincidence is equal to or greater than the threshold value (step S507: YES), the process of the radio device 100 proceeds to step S508. On the other hand, when the degree of coincidence is smaller than the threshold value (step S507: NO), the process of the radio device 100 proceeds to step S509.

The radio device 100 determines that the audio quality of the analog radio audio as a switching destination candidate is “good” (step S508). This process flow ends, and the process proceeds to step S405 in FIG. 4.

The radio device 100 determines that the audio quality of the analog radio audio as the switching destination candidate is “poor” (step S509). This process flow ends, and the process proceeds to step S405 in FIG. 4.

The radio device 100 determines that the audio quality of the analog radio audio as the switching destination candidate is “unknown” (step S510). That is, when either the digital radio or the analog radio for evaluating the audio quality cannot be received, the evaluation result is “unknown”. In the present embodiment, when the evaluation result is “unknown”, it is determined as “YES” in the determination of step S405 in FIG. 4 in the subsequent stage. However, the present disclosure is not limited thereto, and “NO” may be determined in the determination of step S405 in FIG. 4 based on, for example, user setting. This process flow ends, and the process proceeds to step S405 in FIG. 4.

### Modification 1

In the above configuration, the audio quality evaluation is performed based on the degree of coincidence between the analog radio audio and the digital radio audio, but the present disclosure is not limited thereto. Further, the audio quality evaluation may be performed by combining signal intensities of analog radio audios.

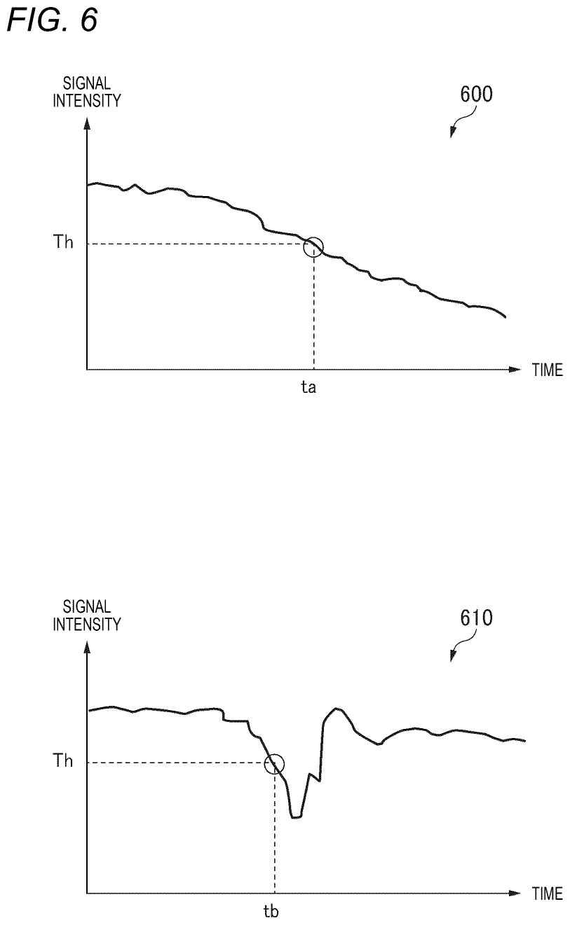

FIG. 6 is a graph illustrating a change in intensity of a radio signal of analog radio broadcasting. In FIG. 6, a vertical axis represents a signal intensity of a radio signal, and a horizontal axis represents the passage of time. The signal intensity of the radio signal and the audio quality have a certain correlation, and when the signal intensity is high, the audio quality also becomes high. Here, a threshold value Th for determining the certainty of an audio quality evaluation result for the analog radio audio may be used. For example, when the signal intensity of the analog radio audio used for the audio quality evaluation exceeds the threshold value, the certainty of the audio quality evaluation result may be high. On the other hand, when the signal intensity of the analog radio audio used for the audio quality evaluation is lower than the threshold value, the certainty of the audio quality evaluation result may be low.

An audio source to be switched may be adjusted based on the certainty of the audio quality evaluation result. A plurality of threshold values may be used to determine the certainty in a stepwise manner according to the threshold values. The threshold value in this case may be, for example, equal to the threshold value for determining whether the analog radio audio can be received in step S503 of FIG. 5.

Further, the audio quality evaluation may be performed by combining change rates of the signal intensities. For example, as illustrated in a graph 610 of FIG. 6, the signal intensity of the analog radio audio temporarily falls below the threshold value Th after a time tb. However, since the signal intensity of the analog radio audio thereafter exceeds the threshold value Th and is in a good state, the audio quality of the analog radio audio is good, and switching to the IP radio audio may not be necessary. In this way, by combining changes in the signal intensity of the analog radio audio in a certain period, more appropriate switching is possible.

### Modification 2

In the above process, the audio quality evaluation unit 110 performs audio quality evaluation using the degree of coincidence based on the inner product of the analog radio audio and the digital radio audio. Alternatively, the audio quality evaluation may be performed based on a difference between the analog radio audio and the digital radio audio, that is, an error signal.

When subtraction is performed between the analog radio audio 300 and the digital radio audio 310 as illustrated in FIG. 3, an error signal 320 is obtained. The error signal 320 includes residual noise 321 and periodic noise 322. The audio quality of the analog radio audio is evaluated according to how much such noise is included in the signal.

First, the audio quality evaluation unit 110 calculates a signal intensity at a predetermined interval for the error signal obtained by the subtraction. Similarly, the audio quality evaluation unit 110 calculates a signal intensity at the predetermined interval for a radio signal of the digital radio audio. A signal intensity power for the signal can be calculated by, for example, the following formula (1).

$$[ Equation 1 ]$$

$$power = \frac{1}{N} {\sum }_{n = 1}^{N} {\vert x ( n ) \vert}^{2} \qquad ( 1 )$$

Here, x (n) is a sample value in a case of n.

Furthermore, the audio quality evaluation unit 110 calculates S/N (signal-to-noise ratio) from a signal intensity power_N of an error signal and a signal intensity power_S of a digital radio signal, and compares the S/N with a predetermined threshold value to evaluate the audio quality of the analog radio audio. Specifically, when power_S/power_N is larger than a predetermined threshold value, the audio quality of the analog radio signal may be determined to be high. The audio quality evaluation unit 110 outputs the audio quality evaluation information on the determined analog radio audio to the audio source switching unit 111, thereby realizing appropriate switching of the audio source.

### Modification 3

In Modification 2, an example of the audio quality evaluation based on an error signal between the analog radio audio and the digital radio audio is described. As illustrated in FIG. 3, the error signal 320 may include the periodic noise 322 that may adversely affect the audio quality. When the periodic noise appears at a relatively small value, if the quality evaluation is performed using only the S/N, an influence of the periodic noise may not be appropriately considered. Therefore, in Modification 3, the audio quality evaluation is performed by further capturing periodic noise.

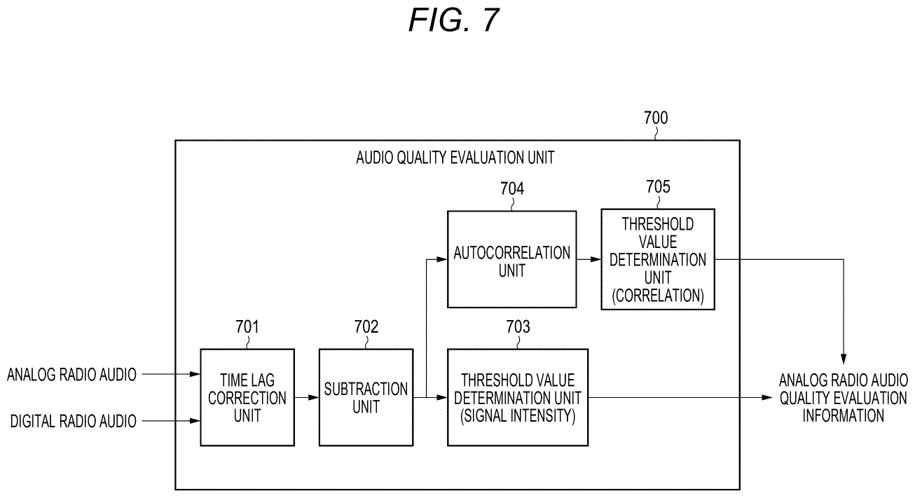

FIG. 7 is a block diagram illustrating a configuration example of an audio quality evaluation unit 700 according to Modification 3. The audio quality evaluation unit 700 includes a time lag correction unit 701, a subtraction unit 702, a threshold value determination unit 703, an autocorrelation unit 704, and a threshold value determination unit 705. The time lag correction unit 701 derives a time lag between the analog radio audio and the digital radio audio, and corrects the time lag. The subtraction unit 702 performs subtraction between the analog radio audio and the digital radio audio, and outputs an error signal as a difference therebetween.

The threshold value determination unit 703 derives the signal intensity and the S/N based on the error signal obtained by the subtraction unit 702 to perform audio quality evaluation. The process here is the same as that in Modification 2. Then, the threshold value determination unit 703 outputs an audio quality evaluation result of the analog radio audio based on the signal intensity.

The autocorrelation unit 704 captures the periodicity of a waveform by performing autocorrelation on the error signal obtained by the subtraction unit 702. A period for determining whether periodic noise appears is not particularly limited, and may be a predetermined time duration. For example, a waveform of the periodic noise 322 illustrated in FIG. 3 is captured. A known method may be used as an autocorrelation method for the waveform, and a detailed description thereof is omitted here.

The threshold value determination unit 705 compares the periodic noise obtained by the autocorrelation unit 704 with a preset threshold value to determine the audio quality of the analog radio audio. When the degree of the periodic noise exceeds the threshold value, the audio quality of the analog radio audio is treated as low. Then, the threshold value determination unit 705 outputs an audio quality evaluation result of the analog radio audio based on the autocorrelation.

### Modification 4

In Modification 3, an example in which an error signal of the analog radio audio and the digital radio audio by the subtraction unit 702 is used has been described. In Modification 4, an example using an adaptive filter will be described. It is assumed that the analog radio audio and the digital radio audio have different frequency characteristics. A modification in which an error signal is obtained after the frequency characteristics are corrected to match the frequency characteristics will be described.

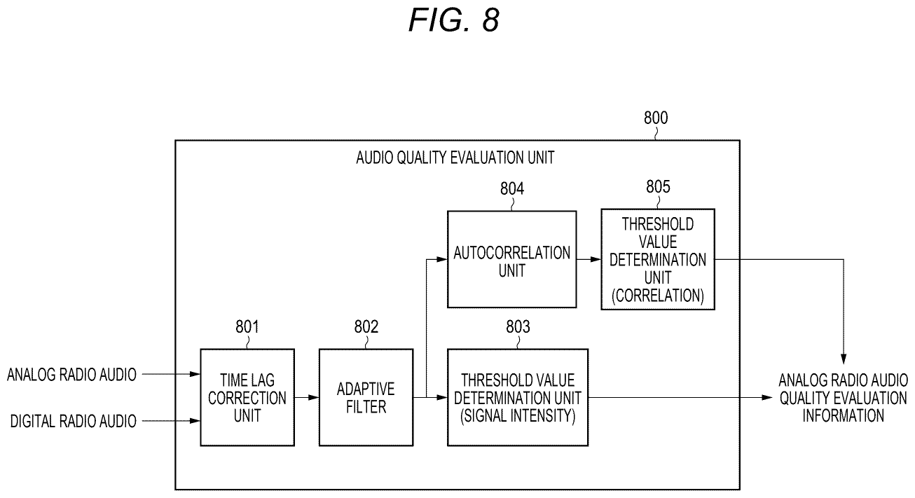

FIG. 8 is a block diagram illustrating a configuration example of an audio quality evaluation unit 800 according to Modification 4. A difference between the audio quality evaluation unit 700 illustrated in FIG. 7 in Modification 3 and the audio quality evaluation unit 800 according to Modification 4 is that an adaptive filter 802 is provided instead of the subtraction unit 702. The configurations of a time lag correction unit 801, a threshold value determination unit 803, an autocorrelation unit 804, and a threshold value determination unit 805 of the audio quality evaluation unit 800 are the same as those in Modification 3.

The adaptive filter 802 corrects frequency characteristics of the digital radio audio so that the frequency characteristics are close to the frequency characteristics of the analog radio audio. A known method may be used as the correction method here, and a detailed description is omitted here. The correction method is performed based on a relation between the frequency characteristics of the analog radio audio and the frequency characteristics of the digital radio audio. After correcting the frequency characteristics, the adaptive filter 802 performs a subtraction process on the analog radio audio and the digital radio audio to derive an error signal. The subsequent processes are the same as those in Modification 3.

### Modification 5

A radio signal may be configured as a stereo signal in a right channel R and a left channel L. In such a configuration, if a process is performed on each channel, a processing load may increase. Modification 5 in which the signals of the two channels are converted into a monaural signal, that is, a sum signal and processed will be described.

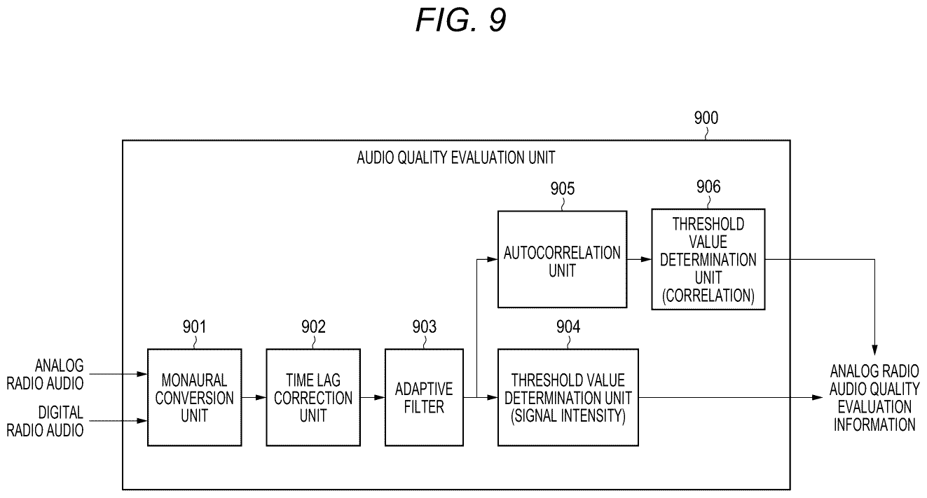

FIG. 9 is a block diagram illustrating a configuration example of an audio quality evaluation unit 900 according to Modification 5. A difference between the audio quality evaluation unit 800 illustrated in FIG. 8 in Modification 4 and the audio quality evaluation unit 900 according to Modification 5 is that a monaural conversion unit 901 is newly added. The configurations of a time lag correction unit 902, an adaptive filter 903, a threshold value determination unit 904, an autocorrelation unit 905, and a threshold value determination unit 906 of the audio quality evaluation unit 900 are the same as those in Modification 4.

The monaural conversion unit 901 combines the right channel R and the left channel L of the analog radio audio, which is a stereo signal, and outputs the combined signal to the time lag correction unit 902 as a monaural signal. Similarly, the monaural conversion unit 901 combines the right channel R and the left channel L of the digital radio audio, which is a stereo signal, and outputs the combined signal to the time lag correction unit 902 as a monaural signal. The subsequent processes are the same as those in Modification 4.

### Modification 6

In Modification 4 or Modification 5, a configuration example in which the frequency characteristic is corrected by an adaptive filter has been described. Such an adaptive filter requires a certain amount of time for correction. In particular, the larger the difference between the frequency characteristics, the higher a correction load. Therefore, in Modification 6, in order to reduce a correction processing load by the adaptive filter, a configuration in which a high-frequency band portion of the frequency of the digital radio signal is removed to be close to the frequency characteristic of the analog radio audio will be described.

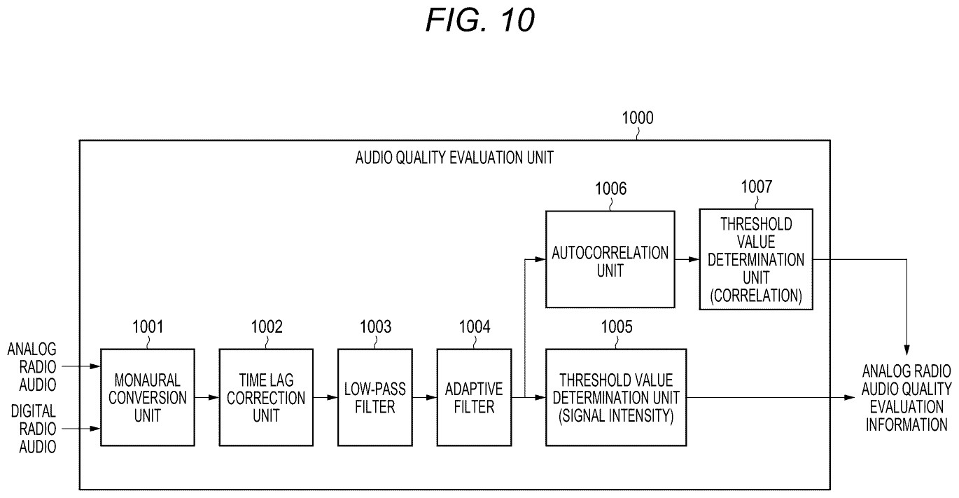

FIG. 10 is a block diagram illustrating a configuration example of an audio quality evaluation unit 1000 according to Modification 6. A difference between the audio quality evaluation unit 900 illustrated in FIG. 9 in Modification 5 and the audio quality evaluation unit 1000 according to Modification 6 is that a low-pass filter 1003 is newly added. The configurations of a monaural conversion unit 1001, a time lag correction unit 1002, an adaptive filter 1004, a threshold value determination unit 1005, an autocorrelation unit 1006, and a threshold value determination unit 1007 of the audio quality evaluation unit 1000 are the same as those in Modification 5.

The low-pass filter 1003 cuts a predetermined high-frequency band portion of the digital radio audio. The frequency band to be cut here is defined based on the frequency characteristics of the analog radio audio and the digital radio audio. Then, the low-pass filter 1003 outputs the processed digital radio audio to the adaptive filter 1004. In such a configuration, the digital radio audio is delayed with respect to the analog radio audio by passing through the low-pass filter 1003. Therefore, the analog radio audio and the digital radio audio are synchronized by applying a delay process corresponding to the delay of the digital radio audio with respect to the analog radio audio by the low-pass filter 1003. In this case, the delay process with respect to the analog radio audio may be performed by a delay circuit (not illustrated). The subsequent processes are the same as those in Modification 5.

### Modification 7

In FIG. 2, a configuration in which the audio quality evaluation of the analog radio audio is performed using the degree of coincidence based on the inner product of the analog radio audio and the digital radio audio has been described. In contrast, the configuration of Modification 6 may be combined.

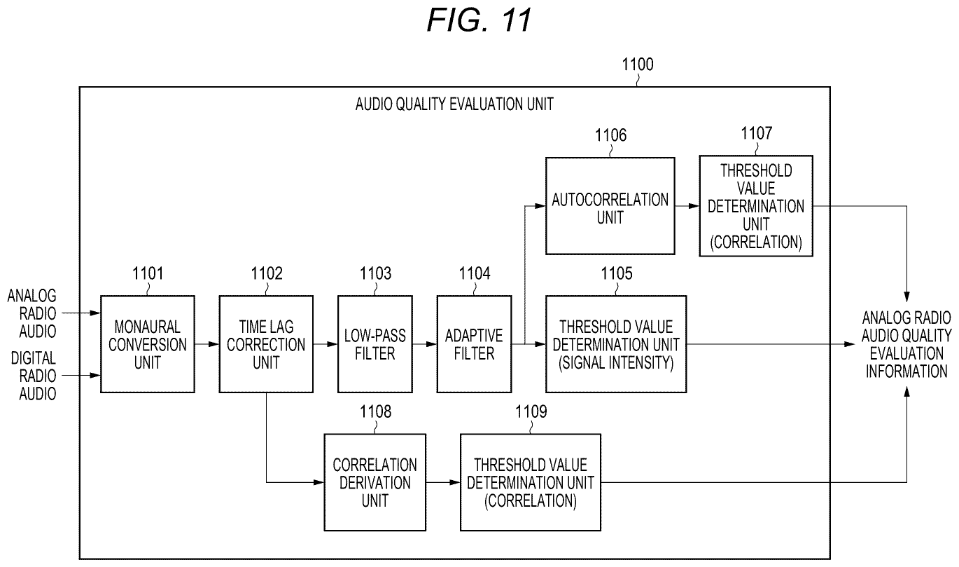

FIG. 11 is a block diagram illustrating a configuration example of an audio quality evaluation unit 1100 according to Modification 7. The audio quality evaluation unit 110 described with reference to FIG. 2 and the audio quality evaluation unit 1000 illustrated in FIG. 10 in Modification 6 are configured in parallel. Processes of components are the same as those in the above-described configuration. Therefore, from the three viewpoints, the audio quality evaluation is performed on the analog radio audio.

When the cross-correlation between the analog radio signal and the digital radio signal is used at the time of deriving a time lag in the time lag correction unit 1102, the correlation is known from the result of the time lag correction unit 1102, and thus a correlation derivation unit 1108 may be omitted. In this case, the correlation information obtained by the time lag correction unit 1102 is directly input to the threshold value determination unit 1109 and used.

When the audio quality evaluation is performed from a plurality of viewpoints as in each modification, comprehensive evaluation of the analog radio audio may be performed by, for example, performing weighting on each result. Further, priority may be defined in each audio quality evaluation item, and comprehensive evaluation may be performed based on the priority.

### [System Configuration Example According to Area]

Each radio broadcasting may have a different broadcasting configuration depending on the area. Hereinafter, a configuration example of a radio device assuming a combination of radio broadcastings in various areas will be described. Here, the audio quality evaluation unit 1000 illustrated in FIG. 10 in Modification 6 is illustrated as an example.

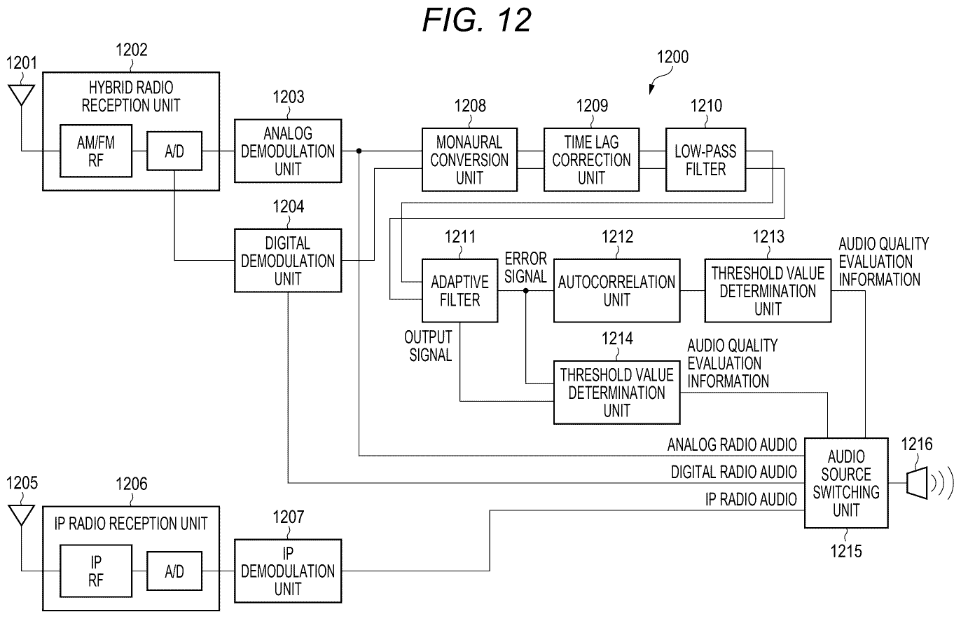

FIG. 12 illustrates a configuration example of a radio device 1200 that can cope with an area where hybrid scheme radio broadcasting for transmitting and receiving a set of a radio signal of analog radio broadcasting and a radio signal of digital radio broadcasting is adopted. Examples of the hybrid scheme include an In-Band On-Channel (IBOC) represented by a Hybrid Digital (HD) radio. The hybrid scheme is a method of performing analog radio broadcasting and digital radio broadcasting using the frequency of existing AM/FM analog broadcasting.

The radio device 1200 corresponding to such an environment receives a radio signal of the hybrid scheme at an antenna 1201 and transmits the radio signal to a hybrid radio reception unit 1202. The hybrid radio reception unit 1202 extracts a radio signal of analog radio broadcasting and a radio signal of digital radio broadcasting from the received radio signal, and outputs the radio signals to an analog demodulation unit 1203 and a digital demodulation unit 1204.

An antenna 1205 receives a radio signal related to IP radio broadcasting and transmits the radio signal to an IP radio reception unit 1206. The IP radio reception unit 1206 performs filtering, A/D conversion, and the like on the received radio signal and provides the radio signal to an IP demodulation unit 1207. The subsequent configuration and processes are the same as those described with reference to FIGS. 1 and 10, and the descriptions thereof are omitted here.

With such a configuration, for example, AM digital radio broadcasting can be appropriately switched to AM analog radio broadcasting having the same content. Similarly, FM digital radio broadcasting can be appropriately switched to FM analog radio broadcasting having the same content.

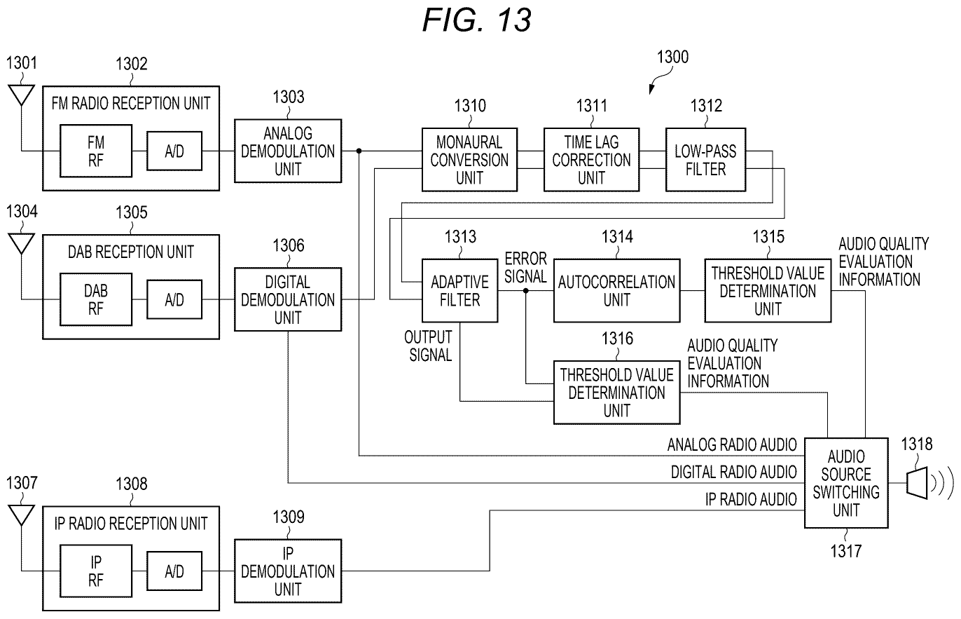

FIG. 13 illustrates a configuration example of a radio device 1300 that can cope with an area where FM analog radio broadcasting and digital audio broadcasting (DAB) corresponding thereto are adopted. Except for the configurations of an FM radio reception unit 1302 and a DAB reception unit 1305 that receive radio signals, other configurations may be the same as those illustrated in FIG. 12.

With this configuration, for example, the DAB digital radio broadcasting can be appropriately switched to the FM analog radio broadcasting having the same content.

In the above configuration example, the switching from the digital radio broadcasting to another radio broadcasting has been described as an example. However, for example, in two analog radio broadcastings having the same service content, the configuration according to the present disclosure is also applicable to switching control in a case where one of the analog radio broadcastings has higher noise resistance and higher audio quality.

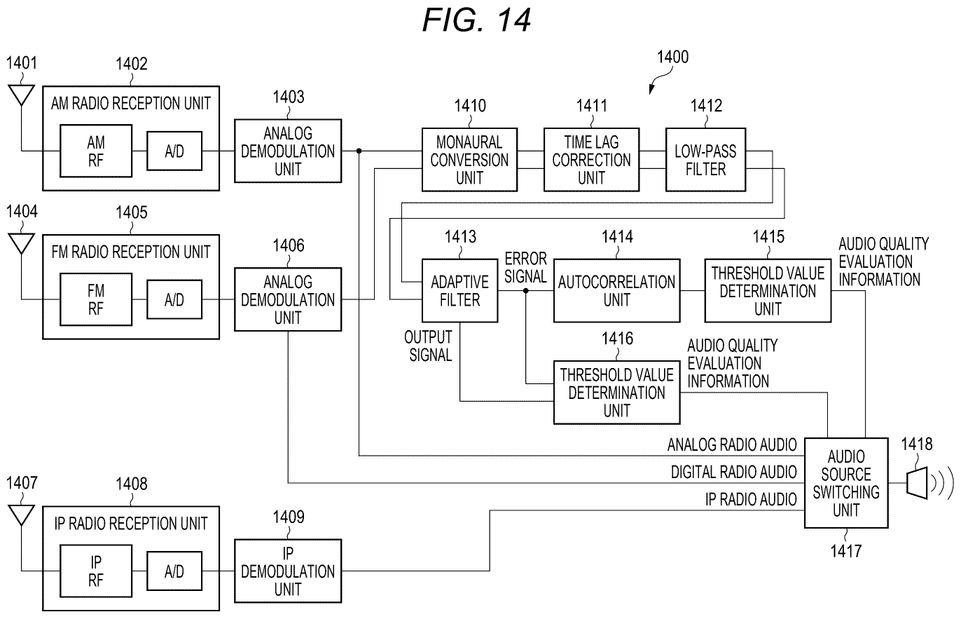

For example, the AM analog radio broadcasting and the FM analog radio broadcasting are adopted, and the FM analog radio broadcasting may have higher noise resistance and higher audio quality. On the other hand, the AM analog radio broadcasting may have a wider reception area. FIG. 14 illustrates a configuration example of a radio device 1400 that can cope with such an area. Except for the configurations of an AM radio reception unit 1402 and an FM radio reception unit 1405 that receive radio signals, other configurations may be the same as those illustrated in FIG. 12. In this case, the FM analog radio broadcasting is positioned with the digital radio broadcasting in the above example to perform the switching process.

As described above, the radio device (for example, 100) according to the present embodiment includes: a reception unit (for example, 101, 102, 104, 105, 107, and 108) that receives a digital radio signal as a radio signal of digital radio broadcasting, an analog radio signal as a radio signal of analog radio broadcasting, and an IP radio signal as a radio signal of IP radio broadcasting, which are related to simulcast broadcasting; an evaluation unit (for example, 110) that performs audio quality evaluation on an analog radio audio by using a digital radio audio based on the digital radio signal and the analog radio audio based on the analog radio signal; and a switching unit (for example, 111) that switches, based on the audio quality evaluation, an audio output of the digital radio audio to any one of the analog radio audio and an IP radio audio based on the IP radio signal. According to this configuration, it is possible to evaluate the audio quality of the radio broadcasting and appropriately switch the radio audio in a radio device mounted on a vehicle or the like.

In the radio device, the switching unit may switch to the analog radio audio when it is determined that the audio quality of the analog radio audio is good based on the audio quality evaluation, and switch to the IP radio audio when it is determined that the audio quality of the analog radio audio is poor based on the audio quality evaluation. According to this configuration, when the audio quality of the analog radio audio deteriorates, it is possible to directly switch an audio output to the IP radio audio without switching the audio output to the analog radio audio.

In the radio device, the evaluation unit may derive a degree of coincidence between the analog radio audio and the digital radio audio, and may evaluate that the audio quality of the analog radio audio is good when the degree of coincidence is equal to or greater than a predetermined threshold value. According to this configuration, it is possible to appropriately perform the audio quality evaluation on the analog radio audio using the degree of coincidence between the analog radio audio and the digital radio audio in which noise is more likely to be included.

In the radio device, the evaluation unit may evaluate that the audio quality of the analog radio audio is good when a signal intensity of noise included in an error signal between the analog radio audio and the digital radio audio is smaller than a predetermined threshold value. According to this configuration, it is possible to appropriately perform the audio quality evaluation on the analog radio audio using an error signal between the analog radio audio and the digital radio audio in which noise is more likely to be included. In particular, it is possible to appropriately capture the residual noise included in the analog radio audio to perform the audio quality evaluation.

In the radio device, the evaluation unit may derive periodic noise included in an error signal between the analog radio audio and the digital radio audio, and evaluate that the audio quality of the analog radio audio is good when the periodic noise is smaller than a predetermined threshold value. According to this configuration, it is possible to appropriately capture the periodic noise included in the analog radio audio to perform the audio quality evaluation.

In the radio device, the evaluation unit may calculate the error signal after correcting frequency characteristics of the analog radio audio and the digital radio audio to match each other. According to this configuration, the evaluation accuracy can be further improved by performing the audio quality evaluation after correcting a difference between the frequency characteristics of the analog radio audio and the frequency characteristics of the digital radio audio.

In the radio device, the evaluation unit may correct the frequency characteristics after applying a low-pass filter corresponding to the analog radio audio to the digital radio audio. According to this configuration, it is possible to reduce a processing load or a processing time for correcting the difference between the frequency characteristics of the analog radio audio and the frequency characteristics of the digital radio audio.

In the radio device, the analog radio audio and the digital radio audio are stereo signals, and the evaluation unit may perform audio quality evaluation after converting each of the analog radio audio and the digital radio audio into a monaural signal. According to this configuration, it is possible to reduce a processing load or a processing time related to the evaluation of the audio quality of the analog radio audio as a stereo signal.

In the radio device, the switching unit may switch an audio to the analog radio audio or the IP radio audio based on the audio quality evaluation when a reception condition of the digital radio broadcasting deteriorates. According to this configuration, it is possible to improve the performance for the user to use the radio device by preferentially outputting an audio of the digital radio broadcasting with higher audio quality in a normal state and switching to another radio broadcasting when the reception condition of the digital radio broadcasting deteriorates.

In the radio device, the switching unit may switch an audio to the analog radio audio when reception conditions of the digital radio broadcasting, the analog radio broadcasting, and the IP radio broadcasting all deteriorate. According to this configuration, even when a reception condition of any radio broadcasting deteriorates, it is possible to prevent a situation in which a silent audio is output.

### Other Embodiments

In the above embodiments, switching from a digital radio audio to another radio audio has been described as an example. However, the present disclosure is not limited thereto, and may be applied to other switching. For example, the present disclosure may be applied to switching when IP radio broadcasting is outputting an audio. It may compare the radio audio and the IP radio audio of the analog radio broadcasting, which are related to the IP radio broadcasting and the simulcast broadcasting that are outputting an audio, and to control whether to switch to the analog radio audio. Accordingly, for example, when it is desired to reduce the payment of a fee for use of the IP radio broadcasting as much as possible, it is possible to seamlessly switch to another simulcast broadcasting based on the audio quality.

It is also possible to implement a process in which programs and applications for implementing the functions of the one or more embodiments described above are supplied to a system or device using a network, storage medium, or the like, and are read and executed by one or more processors in a computer of the system or device.

The process may be implemented by a circuit (for example, application specific integrated circuit (ASIC) or field programmable gate array (FPGA)) that implements one or more functions.

Although various embodiments have been described above with reference to the drawings, it is needless to say that the present disclosure is not limited to such examples. It is apparent to a person skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, the components in the various embodiments described above may be combined freely in a range without deviating from the spirit of the disclosure.

### APPENDIX

The following techniques are disclosed based on the above description of the embodiments.

### (Technique 1)

A radio device includes: a reception unit configured to receive a digital radio signal as a radio signal of digital radio broadcasting, an analog radio signal as a radio signal of analog radio broadcasting, and an IP radio signal as a radio signal of IP radio broadcasting, the digital radio broadcasting, the analog radio broadcasting, and the IP radio broadcasting being related to simulcast broadcasting; an evaluation unit configured to perform audio quality evaluation on an analog radio audio by using a digital radio audio based on the digital radio signal and the analog radio audio based on the analog radio signal; and a switching unit configured to switch, based on the audio quality evaluation, an audio output of the digital radio audio to any one of the analog radio audio and an IP radio audio based on the IP radio signal.

According to this configuration, it is possible to evaluate the audio quality of the radio broadcasting and appropriately switch the radio audio in a radio device mounted on a vehicle or the like.

### (Technique 2)

In the radio device according to the technique 1, the switching unit is configured to: switch to the analog radio audio when the radio device determines that an audio quality of the analog radio audio is good based on the audio quality evaluation; and switch to the IP radio audio when the radio device determines that the audio quality of the analog radio audio is poor based on the audio quality evaluation.

According to this configuration, when the audio quality of the analog radio audio deteriorates, it is possible to directly switch an audio output to the IP radio audio without switching the audio output to the analog radio audio.

### (Technique 3)

In the radio device according to the technique 2, the evaluation unit is configured to: derive a degree of coincidence between the analog radio audio and the digital radio audio; and evaluate that the audio quality of the analog radio audio is good when the degree of coincidence is equal to or greater than a predetermined threshold value.

According to this configuration, it is possible to appropriately perform the audio quality evaluation on the analog radio audio using the degree of coincidence between the analog radio audio and the digital radio audio in which noise is more likely to be included.

### (Technique 4)

In the radio device according to the technique 2 or 3, the evaluation unit is configured to evaluate that the audio quality of the analog radio audio is good when a signal intensity of noise included in an error signal between the analog radio audio and the digital radio audio is smaller than a predetermined threshold value.

According to this configuration, it is possible to appropriately perform the audio quality evaluation on the analog radio audio using an error signal between the analog radio audio and the digital radio audio in which noise is more likely to be included. In particular, it is possible to appropriately capture the residual noise included in the analog radio audio to perform the audio quality evaluation.

### (Technique 5)

In the radio device according to any one of the techniques 2 to 4, the evaluation unit is configured to: derive periodic noise included in an error signal between the analog radio audio and the digital radio audio; and evaluate that the audio quality of the analog radio audio is good when the periodic noise is smaller than a predetermined threshold value.

According to this configuration, it is possible to appropriately capture the periodic noise included in the analog radio audio to perform the audio quality evaluation.

### (Technique 6)

In the radio device according to the technique 4 or 5, the evaluation unit is configured to calculate the error signal after correcting frequency characteristics of the analog radio audio and the digital radio audio to match with each other.

According to this configuration, the evaluation accuracy can be further improved by performing the audio quality evaluation after correcting a difference between the frequency characteristics of the analog radio audio and the frequency characteristics of the digital radio audio.

### (Technique 7)

In the radio device according to the technique 6, the evaluation unit is configured to correct the frequency characteristics after applying a low-pass filter to the digital radio audio, the low-pass filter corresponding to the analog radio audio.

According to this configuration, it is possible to reduce a processing load or a processing time for correcting the difference between the frequency characteristics of the analog radio audio and the frequency characteristics of the digital radio audio.

### (Technique 8)

In the radio device according to any one of the techniques 1 to 7, the analog radio audio and the digital radio audio are stereo signals. The evaluation unit is configured to perform the audio quality evaluation after converting each of the analog radio audio and the digital radio audio into a monaural signal.

According to this configuration, it is possible to reduce a processing load or a processing time related to the evaluation of the audio quality of the analog radio audio as a stereo signal.

### (Technique 9)

In the radio device according to any one of the techniques 1 to 8, the switching unit is configured to switch a radio audio to the analog radio audio or the IP radio audio based on the audio quality evaluation, when a reception condition of the digital radio broadcasting deteriorates.

According to this configuration, it is possible to improve the performance for the user to use the radio device by preferentially outputting an audio of the digital radio broadcasting with higher audio quality in a normal state and switching to another radio broadcasting when the reception condition of the digital radio broadcasting deteriorates.

### (Technique 10)

In the radio device according to any one of the techniques 1 to 9, the switching unit is configured to switch a radio audio to the analog radio audio, when reception conditions of the digital radio broadcasting, the analog radio broadcasting, and the IP radio broadcasting all deteriorate.

According to this configuration, even when a reception condition of any radio broadcasting deteriorates, it is possible to prevent a situation in which a silent audio is output.

### (Technique 11)

A radio device control method includes: a reception operation of receiving a digital radio signal as a radio signal of digital radio broadcasting, an analog radio signal as a radio signal of analog radio broadcasting, and an IP radio signal as a radio signal of IP radio broadcasting, the digital radio broadcasting, the analog radio broadcasting, and the IP radio broadcasting being related to simulcast broadcasting; an evaluation operation of performing audio quality evaluation on an analog radio audio by using a digital radio audio based on the digital radio signal and the analog radio audio based on the analog radio signal; and a switching operation of switching, based on the audio quality evaluation, an audio output of the digital radio audio to any one of the analog radio audio and an IP radio audio based on the IP radio signal.

According to this configuration, it is possible to evaluate the audio quality of the radio broadcasting and appropriately switch the radio audio in a radio device mounted on a vehicle or the like.

### (Technique 12)

There are provided a program for causing a computer to execute a control process, and a non-transitory computer readable medium storing the program. The control process includes: a reception operation of receiving a digital radio signal as a radio signal of digital radio broadcasting, an analog radio signal as a radio signal of analog radio broadcasting, and an IP radio signal as a radio signal of IP radio broadcasting, the digital radio broadcasting, the analog radio broadcasting, and the IP radio broadcasting being related to simulcast broadcasting; an evaluation operation of performing audio quality evaluation on an analog radio audio by using a digital radio audio based on the digital radio signal and the analog radio audio based on the analog radio signal; and a switching operation of switching, based on the audio quality evaluation, an audio output of the digital radio audio to any one of the analog radio audio and an IP radio audio based on the IP radio signal.

According to this configuration, it is possible to evaluate the audio quality of the radio broadcasting and appropriately switch the radio audio in a radio device mounted on a vehicle or the like.

What is claimed is:

1. A radio device comprising:
a memory in which a program is stored; and
a processor coupled to the memory and configured to perform processing by executing the program, the processing including:
receiving a digital radio signal as a radio signal of digital radio broadcasting, an analog radio signal as a radio signal of analog radio broadcasting, and an IP radio signal as a radio signal of IP radio broadcasting, the digital radio broadcasting, the analog radio broadcasting, and the IP radio broadcasting being related to simulcast broadcasting;
performing audio quality evaluation on an analog radio audio by using a digital radio audio based on the digital radio signal and the analog radio audio based on the analog radio signal; and
switching, based on the audio quality evaluation, an audio output of the digital radio audio to any one of the analog radio audio and an IP radio audio based on the IP radio signal.

2. The radio device according to claim 1, wherein
the switching of the audio output includes:
switching to the analog radio audio when the radio device determines that an audio quality of the analog radio audio is good based on the audio quality evaluation; and
switching to the IP radio audio when the radio device determines that the audio quality of the analog radio audio is poor based on the audio quality evaluation.

3. The radio device according to claim 2, wherein
the performing of the audio quality evaluation includes:
deriving a degree of coincidence between the analog radio audio and the digital radio audio; and
evaluating that the audio quality of the analog radio audio is good when the degree of coincidence is equal to or greater than a predetermined threshold value.

4. The radio device according to claim 2, wherein
the performing of the audio quality evaluation includes evaluating that the audio quality of the analog radio audio is good when a signal intensity of noise included in an error signal between the analog radio audio and the digital radio audio is smaller than a predetermined threshold value.

5. The radio device according to claim 2, wherein
the performing of the audio quality evaluation includes:
deriving periodic noise included in an error signal between the analog radio audio and the digital radio audio; and
evaluating that the audio quality of the analog radio audio is good when the periodic noise is smaller than a predetermined threshold value.

6. The radio device according to claim 4, wherein
the performing of the audio quality evaluation includes calculating the error signal after correcting frequency characteristics of the analog radio audio and the digital radio audio to match with each other.

7. The radio device according to claim 6, wherein
the performing of the audio quality evaluation includes correcting the frequency characteristics after applying a low-pass filter to the digital radio audio, the low-pass filter corresponding to the analog radio audio.

8. The radio device according to claim 1, wherein
the analog radio audio and the digital radio audio are stereo signals, and
the performing of the audio quality evaluation includes performing the audio quality evaluation after converting each of the analog radio audio and the digital radio audio into a monaural signal.

9. The radio device according to claim 1, wherein
the switching of the audio output includes switching the audio output to the analog radio audio or the IP radio audio based on the audio quality evaluation, when a reception condition of the digital radio broadcasting deteriorates.

10. The radio device according to claim 1, wherein
the switching of the audio output includes switching the audio output to the analog radio audio, when reception conditions of the digital radio broadcasting, the analog radio broadcasting, and the IP radio broadcasting all deteriorate.

11. A radio device control method comprising:
receiving a digital radio signal as a radio signal of digital radio broadcasting, an analog radio signal as a radio signal of analog radio broadcasting, and an IP radio signal as a radio signal of IP radio broadcasting, the digital radio broadcasting, the analog radio broadcasting, and the IP radio broadcasting being related to simulcast broadcasting;
performing audio quality evaluation on an analog radio audio by using a digital radio audio based on the digital radio signal and the analog radio audio based on the analog radio signal; and
switching, based on the audio quality evaluation, an audio output of the digital radio audio to any one of the analog radio audio and an IP radio audio based on the IP radio signal.

12. A non-transitory computer readable medium storing a program for causing a computer to execute a control process, the control process comprising:
receiving a digital radio signal as a radio signal of digital radio broadcasting, an analog radio signal as a radio signal of analog radio broadcasting, and an IP radio signal as a radio signal of IP radio broadcasting, the digital radio broadcasting, the analog radio broadcasting, and the IP radio broadcasting being related to simulcast broadcasting;
performing audio quality evaluation on an analog radio audio by using a digital radio audio based on the digital radio signal and the analog radio audio based on the analog radio signal; and
switching, based on the audio quality evaluation, an audio output of the digital radio audio to any one of the analog radio audio and an IP radio audio based on the IP radio signal.
